(19) United States
(12) Patent Application Publication
(10) Pub. No.: US 2008/0270227 A1
(43) Pub. Date: Oct. 30, 2008

(54) System for Checking the Payment of Vehicle Parking Charges

(76) Inventor: Moosa Eisa Al Amri, Dubai (AE)

Correspondence Address: STURM & FIX LLP, 206 SIXTH AVENUE, SUITE 1213, DES MOINES, IA, 50309-4076, US

(21) Appl. No.: 12/091,373

(22) PCT Filed: Oct. 19, 2006
(86) PCT No.: PCT/IB2006/003062

§ 371 Date: Apr. 24, 2008

(30) Foreign Application Priority Data
Oct. 29, 2005 (AE) 587/2005
Jun. 1, 2006 (IB) PCT/IB2006/001470

(51) Int. Cl. G07B 15/00

(52) U.S. Cl. 705/13; 340/932.2

(57) ABSTRACT

A system for checking the payment of vehicle parking charges comprises, on the one hand, a vehicle-portable parking meter device (12) for paying vehicle parking charges and, on the other hand, a portable hand-held parking checker device (11) for checking parking charges. The parking meter device (12) comprises a contact or contactless storage chip (15) that is loadable with an amount of credit usable as parking fees, the storage chip being associated with an antenna (16) for wireless connection of the storage chip with a wireless-operable credit-loading device (17,303,403). The portable hand-held checker device (11) is usable by a parking inspector (13) to check the payment status of a parking meter device (12) that is installed in or on a parked vehicle (14). The checker device (11), when in the vicinity of the parked vehicle, is connectable with the parking meter device's storage chip via its antenna (16) using a local short-distance wireless or RPID or IR transmission whereby the parking inspector can check whether or not the parking meter device (12) has residual paid parking time.

### FIELD OF THE INVENTION

The invention relates to a system for checking the payment of vehicle parking charges comprising, on the one hand, a vehicle-portable parking meter device for paying vehicle parking charges and, on the other hand, a portable hand-held parking checker device for checking parking charges. The system comprises a pager device and system for parking payment charges in order to pay the required charges of the vehicle in private or public paying car parks, highway parking, main road parking in charged parking areas, and with simplification of control by parking inspectors using the portable hand-held parking checker device.

### BACKGROUND OF THE INVENTION

The invention relates to the problem of car parking in paying parking areas, especially in the winter or summer season, or when the motorist parking his vehicle is not able to come back again to the vehicle to pay the charges for a further period, especially if he was busy in a business meeting, forgot to pay the required charges, or late to pay a charge for an extended time, and allowing also the possibility to pay a fine for not paying the car parking charges. To avoid the above-mentioned problem, the invention aims to provide a system with easier possibilities for drivers and car owners and simplification of control by parking inspectors.

Various proposals for parking schemes include the following.

U.S. Pat. No. 6,102,285 describes a parking meter system in which a user-operated display device is placed in the car. Payment of the parking charge is made using a pre-paid debit card or by deduction from a pre-purchased amount. The display is illuminated during the parking period. The paid parking period can be checked visually by a parking attendant, or by remote control using a radio frequency transmission.

U.S. Pat. No. 6,097,106 discloses a vehicle security system for valet parking where the parking attendant uses a pager to retrieve a parked vehicle.

WO 01/31485 discloses an internet payment system applicable inter alia for parking lot payments.

U.S. Pat. No. 6,559,776 describes a car parking system where occupancy of specific parking places in a parking lot is controlled by a computer system cooperating with a portable transceiver placed in each parked car, the transceiver having a display and a device for debiting parking charges for example with a debit or credit card.

DE 197 49 578 and WO 2000/005685 disclose parking meter systems with a pager installed inside a vehicle having a display screen and a storage chip which is loadable with an amount of credit. The pager is connected to a payment server via a network like GPS using dual transmission. The parking time and place can be input and the server sends a confirmation of payment to the pager and the paid parking time is displayed on the screen.

WO 2005/031494 discloses a vehicle-portable parking meter device for paying vehicle parking charges, comprising a radio-operable pager having a contact or contactless storage chip, the pager being installed or installable in or on a vehicle, the storage chip being loadable with an amount of credit usable as parking fees by connection of the storage chip with a credit-loading device, and the storage chip being connectable via a GSM or other wide-area radio network to a payment server for paying parking fees by deduction from the amount of credit in the storage chip.

In known parking payment systems, the car owner sends his number plate and message to a central server for charging parking charges using SMS in a wide-area telephone network such as the GSM network. A parking inspector carries a hand-carried checking device which also operates using SMS via the GSM network. For instance, the inspector uses his hand-held device to get information about the vehicle with the specified number plate by SMS via the GSM network.

### SUMMARY OF THE INVENTION

The invention relates to a system for checking the payment of vehicle parking charges that comprises, on the one hand, a vehicle-portable parking meter device for paying vehicle parking charges and, on the other hand, a hand-held portable parking checker device for checking parking charges made on a pager installed in or on a given vehicle.

The portable hand-held checker device will be used by a car parking inspector to check the paid parking charges; the parking meter device can include a pager that can be kept on the dashboard of a car or in any suitable place for the inspector to check the parking charges using the portable hand-held checker device.

The portable hand-held checker device is designed specifically for checking the parking charges made with the device described in WO 2005/031494, but can also be used in similar environments.

The parking meter device comprises a contact or contactless storage chip that is loadable with an amount of credit usable as parking fees, the storage chip being associated with an antenna for wireless connection of the storage chip with a wireless-operable credit-loading device. The portable hand-held checker device is usable by a parking inspector to check the payment status of a parking meter device that is installed in or on a parked vehicle. The checker device, when in the vicinity of the parked vehicle, is connectable with the parking meter device's storage chip via its antenna using a local short-distance wireless or RFID or IR transmission whereby the parking inspector can check whether or not the parking meter device has residual paid parking time.

Thus, the checker device and a parking meter device (pager) installed in or on a given vehicle are selectively operatively connectable for transmission, from the pager to the checker device, via a local short-distance wireless or RFID or infra-red transmission, of a signal indicating whether or not after the parking server has effected payment of a parking fee the pager has residual paid parking fee or a corresponding residual paid time.

One embodiment of the system further comprises a wireless-operated credit-loading device that comprises a local charging station having a wireless transceiver, the local charging station being equipped with a notebook or PC with charging-station software. The local charging station is operably connectable to the parking meter device by short-distance wireless or RFID or IR transmission when the local charging station and the parking meter device are in the vicinity of one another.

In another embodiment, the parking meter device is connectable via GSM or other wide-area radio network to a remote payment server for loading credit and paying parking fees by deducting from the amount of credit in the storage chip.

“Local wireless application” has its usual meaning of short-distance wireless operating over a range of typically a few meters to a few tens of meters. “Wide-range radio network” also has its usual meaning of a network that can extend over huge distances and includes for example the GPS telephone network.

Preferably, storage chips of the parking meter device and the checker device are each associated with a RFID (radio frequency identification device) incorporating an antenna, and the local wireless application operates with RFID technology, i.e. typically the portable hand-held checker device comprises a RFID reader. An active RFID can be incorporated in the pager and/or in the portable hand-held checker, powered to increase the range of the short-distance RFID transmission.

The hand-held device will thus read and detect the parking device through receiving a RFID signal from the pager device (that can include an active RFID powered by a wireless device for longer range, if required).

Also, the pager device can remain hidden in the car's dashboard in a drawer, or in any other suitable place to discourage theft.

The portable hand-held checker device can also be used simply to check parking status, or can be used for different purposes, including to detect the situation of the car parking device, to re-charge the parking device with money of the device is fixed permanently in the car, for generating on-the-spot fines, and so on.

The checker device can be arranged to send a signal that triggers renewal of a paid parking period on the pager via the GSM or other wide-area radio network; for example the checker device is arranged to send said signal that triggers renewal of a paid parking period on the pager via the local short-distance wireless or RFID or infra-red transmission.

The parking meter device can be arranged for entering an intended parking time and an identification of the parking place by manual actuation of the pager or by remote control via the wide-area radio network or via the local short-distance wireless application, and for transmitting a message corresponding to the intended parking time and parking place to the payment server.

The device can include a pager provided with a display screen for displaying paid parking time, the pager in this instance being installed or installable in or on a vehicle such that the display screen is if desired visible from outside the vehicle, or could be stored in a dashboard compartment. This display screen can be arranged to display paid parking time in correspondence with the intended parking time and with an amount of credit deducted as paid parking fee, paid parking time being displayed by the display screen in response to a confirmation-of-payment message sent from the payment server to the pager.

The invention also concerns a portable hand-held parking checker device of the above-described system, wherein the checker device is operatively connectable to the pager by a local short-distance wireless or RFID or infra-red transmission, the checker device comprising a screen for displaying information about vehicle parking charges transmitted by the pager via the local short-distance wireless or RFID or infra-red transmission.

The portable hand-held checker device will typically include an oblong more-or-less parallelepipedic housing having on its upper face a screen and a set of control buttons or a keyboard. The housing will include a RFID or other short-distance radio emitter/receiver and the necessary software. Additionally, the housing may include a printer and its associated equipment.

In preferred embodiments, the checker device comprises a RFID reader.

The checker device can also be also operatively connectable to the wide-area wireless network.

Advantageously, the portable hand-held checker device comprises means for generating parking tickets including an indication of a surcharge or fine as a function of information, transmitted by the pager via the local short-distance wireless or RFID or infra-red transmission, concerning unpaid or expired parking time.

In summary, the invention proposes a system for checking the payment of vehicle parking charges comprising a vehicle-portable parking meter device for paying parking charges and for displaying paid parking time, this device comprising a radio-operable pager having a display and a contact or contactless storage chip. The pager is installed or installable in or on a vehicle preferably such that the display is visible from outside the vehicle. The storage chip is loadable by connection with a credit-loading device with an amount of credit usable as parking fees. The storage chip is connectable either via a local charging station using short-distance radio or RFID or IR transmission via a GSM or other wide-area radio network to a payment server for paying parking fees by deduction from the amount of credit in the storage chip. The device can be arranged for entering an intended parking time and an identification of a parking place where the vehicle is parked. These entries are made either by manual actuation of the pager, for example by the pager having a keyboard for entering data, or by remote control via a radio network typically using the motorist's GSM mobile phone, so the entries result in transmitting a message corresponding to the intended parking time and parking place to the payment server. The pager's optional display screen is arranged to display paid parking time in correspondence with the intended parking time and with an amount of credit deducted as paid parking fee. Paid parking time is displayed by the display screen in response to a confirmation-of-payment message sent from the payment server to the pager.

The invention also concerns a system for paying parking charges and for displaying paid parking time, comprising a vehicle-portable parking meter device as set out above, and a payment server for paying parking fees by deduction from the amount of credit in the pager's storage chip which is connectable either via a local charging station using short-distance radio or RFID or IR transmission, or via a GSM or other wide-area radio network to the payment server. The payment server usually cooperates with an authentication server. The system is arranged to operate in the same way as set out above for the device. In one arrangement where an intended parking time and an identification of a parking place are entered by manual actuation of the pager keyboard, the confirmation-of-payment message is sent back to the pager along the same route along which it received its message, by a dual-route transmission. In another arrangement where an intended parking time and an identification of a parking place are entered via a radio network using for example a telephone at a location that can be remote from the parked vehicle, the confirmation-of-payment message is sent to the pager via another wide-area radio network connection.

The invention thus pertains to a pager device or display unit for use when parking in charged car parking areas, that contains a storage chip with a cash loading capacity to pay the parking charges. On the other hand, this invention makes use of electronic communication methods, including paying the car parking charges, using the pager to pay or with display unit (pre-paid, or through authorization station). Payment can be executed through a mobile phone, normal phone device, or any other communication unit.

The device and system combine ease of use and convenience for the motorist, simple management for the issuing authority and for the management authority in charge of the payment server, and reliable and simplified control of the parking payments.

In one embodiment, the pager comprises a plurality of function keys enabling the user to actuate different functions on the device including selection of payment methods and display of selected information such as a payment amount. For example, the pager comprises one function key for actuating automatic renewal of a parking period and displaying an extended paid parking time when a paid parking period expires.

The storage chip of the pager also stores control programs for managing functions performed by the pager. These programs will be provided for carrying out all intended functions including those described herein. The programs can be provided or approved by the authority that issues the pager device. The same authority can coordinate the payment server and authorization server and their associated programs and overview the necessary arrangements for transferring the payments to the owners of the parking spaces.

The parking meter also optionally comprises means for illuminating the display screen that can be actuated by a proximity sensor responsive to a hand passing over the display, for facilitating checking of the display by a parking attendant at night or in poor lighting conditions.

In general, the parking meter device according to the invention can be used in an electronic payment method used by the vehicle driver, owner or others to pay parking charges by stored cash in the pager equipped with contact/contact less card (i.e. combi card or other) through display unit, to pay parking charges from the stored value, pay highway tolls, entrance charges to private areas, etc.

The pager device will receive messages from a dispatcher station, or an authorized payment server through low bit rate radio frequency communication channel. These messages could be numerical message service NMS or services of another wide-area mobile network (GSM/GPRS, SDMA, SDMA 2000), or any other network to display the required time according to the received instruction of the device. Beside, as the first embodiment of the current invention, the pager device includes a number of keys, which allows the motorist to choose the payment order, to be sent through the dispatcher station, payment server, required time order which send an order of the required parking hours, or payments of highway tolls.

The invention relates to a pager, or display unit having a program connected with a contact or contactless chip, and working by many ways as:

1. When the motorist wishes to pay car parking charges, he/she will press the key pad of the pager to pay the parking charges for a desired time at an identified parking location, the charge will be processed by the local charging device or a remote payment server that will send a confirmation-of-payment message to provide a display of the paid parking period on the pager screen, and the motorist will put the display unit or pager in the front of the car typically behind the front windscreen, which allows a parking attendant or inspector to the check the paid period.

2. If the motorist while being far from his vehicle, wishes to extend the parking period, and is unable to reach his vehicle because of his meetings or professional obligations or otherwise, he can send an order or instruction through his mobile phone, by keying in a chosen parking period and sending the order. After this, the newly-set time will be displayed on his vehicle in the parking area by the pager or display device placed behind the car's windscreen.

3. When a parking inspector needs to check the status of the parking payments, this can be done easily and individually by the inspector approaching the given vehicle within the range the hand-held portable checking device's local wireless or RFID or IR transmission, and actuating the hand-held portable checker device.

As stated above, the hand-held portable checker device carried by a parking inspector can be selectively operatively connected with a pager installed in or on a given vehicle. In this way the parking inspector, by actuating the hand-held portable checker device can initiate transmission from the pager to the checker device, via a local wireless or RFID or infra-red transmission, of a signal indicating whether or not after the parking server has effected payment of a parking fee by the via wide-area radio network the pager has residual paid parking fee or a corresponding residual paid time. This signal can for instance be a binary OK or NOT signal, indicating by a colour or a sign that there is a residual parking fee or residual parking time, or by another colour or sign if there is no residual parking time, or if paid parking time has expired or if there is no signal (for instance if there is no pager in the vehicle or if the pager is switched OFF). Alternatively, this signal may indicate the amount of residual parking payment or corresponding time, or the status such as the time elapsed since expiry of a paid parking fee, etc.

Checking of the status of paid parking fees can thus be performed simply and rapidly for individual vehicles with an easy-to-use hand-held portable checker device of simple construction, without the need to rely on a connection to the wide-range wireless network.

By using the preferred RFID technology, both the checker device and the pager's chip/antenna can be constructed with simple and readily-available components providing reliable operation without relying on a wide-range wireless network.

### BRIEF DESCRIPTION OF THE DRAWINGS

FIG. 1A: Illustrates a diagram of an example of a portable hand-held checker device used by a parking inspector to check the payment status of a pager in a vehicle.

FIG. 1B: Illustrates a diagram of an example of a parking meter device's pager interacting on one the one hand with a portable hand-held checker and on the other hand with a local charging station of a credit loading device.

FIG. 2: Illustrates an example of a pager device according to the invention with keypad, display monitor and optional solar battery recharging unit.

FIG. 3: Illustrates a diagram of one example of connecting the pager of the invention to a payment server via a communications network.

FIG. 4: Illustrates a diagram of another example of connecting the pager of the invention to a payment server this time via a dual-route communications network.

FIG. 5: Illustrates a diagram of a car parking pager that accepts a pre-paid card.

FIG. 6: Illustrates a diagram of a car parking pager that has a solar charging device with a built-in antenna.

### DETAILED DESCRIPTION

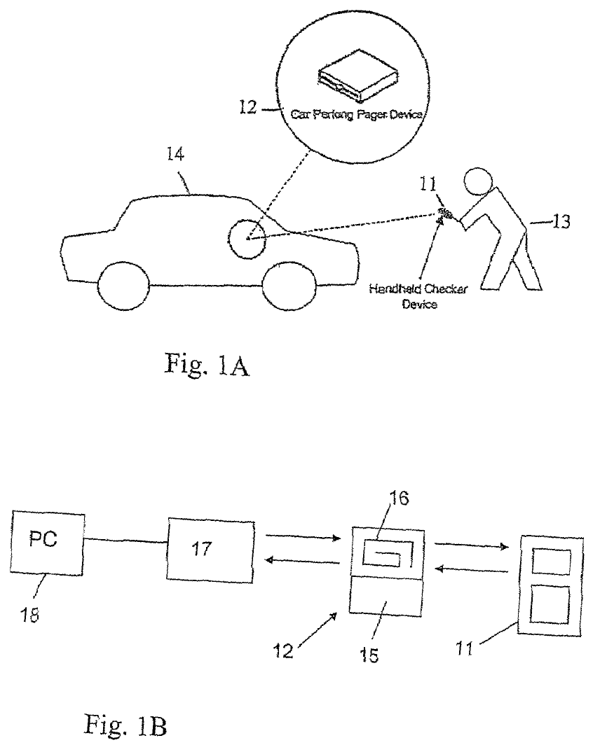

FIG. 1A diagramatically illustrates a portable hand-held checker device 11 used by a parking inspector 13 to check the payment status of a car parking pager device 12 that is installed in a parked automobile vehicle 14. Using this checker device 11, the inspector can check whether or not the pager device 12 has residual paid parking time, as described below, using a local short-distance wireless application or IR transmission.

FIG. 1B illustrates a parking pager device 12 having a storage chip 15 associated with an antenna 16 suitable as a short-distance wireless transceiver, typically using RFID technology. The parking pager device 12 can be installed in a car and interacts, on the one hand, with the portable hand-held checker device 11 and, on the other hand with the local charging station 17 of a wireless-operated local credit loading device 17 that is associated with a notebook or PC 17 having charging-station software.

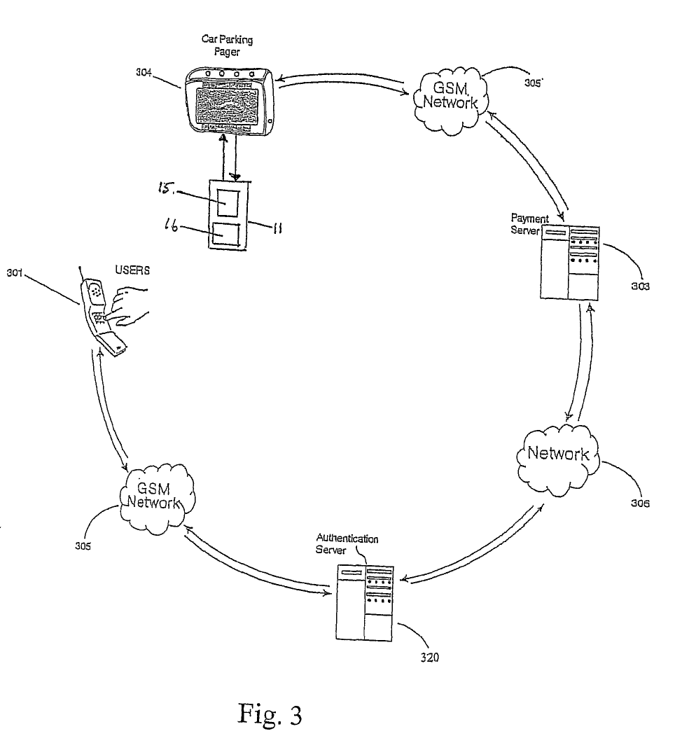

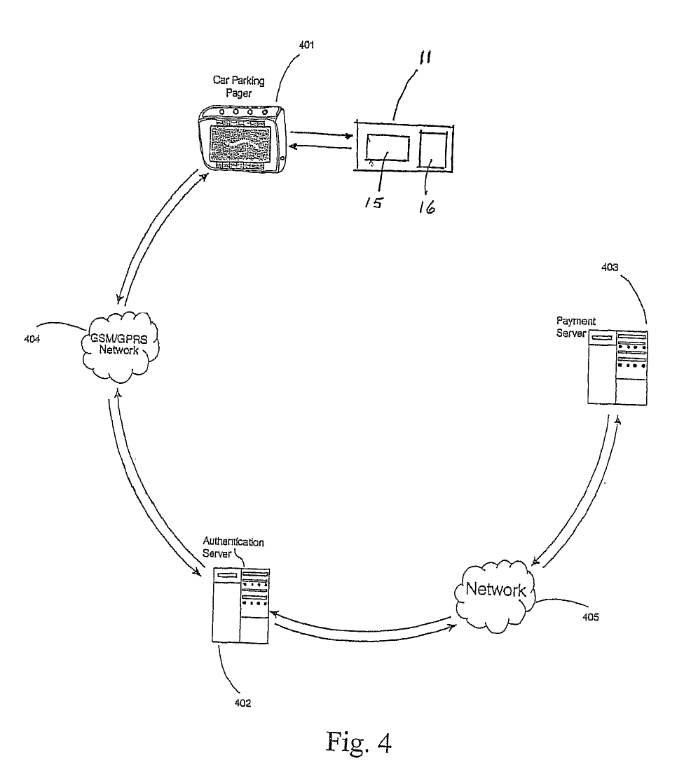

As shown in FIGS. 3 and 4, the checker device 11 can include a screen 15 and a keyboard 16. It can also include a printer.

The portable hand-held checker device 11 is coupled on the one hand to the parking pager device 12 and on the other hand to the credit loading device 17 by means of short-range wireless technology such as an ISM-radio link with RFID technology, or by IR (infra-red) transmission. The chosen data link can for example be a 433 MHz ISM-band, or any other suitable frequency for detecting and verifying the parking charges of the pager device 12. The said data link will detect and verify the valid device addressing and also provide an anti-collision bi-directional data transport system between the checker 11 and the pager 12 and between the pager 12 and the charging station 17.

As illustrated in FIG. 1B, the credit loading device 17 is a local device that has to be in the proximity of the parking device to carry out credit loading operations. At least one of the credit loading device 17 and the pager 12 is mobile so the two can be brought together within the range of the short-distance wireless or RFID or IR transmission.

Alternatively the credit-loading device can be remote. Remote credit loading devices are described with reference to FIGS. 3 and 4.

The car parking inspector 13 can also generate fine tickets for unpaid car parking charges or wrongly-parked cars directly through the hand-held device 11, and he can obtain, through the GSM or another wide-range telephone network, any required electronically-transferred data by connecting to a police or municipal computer.

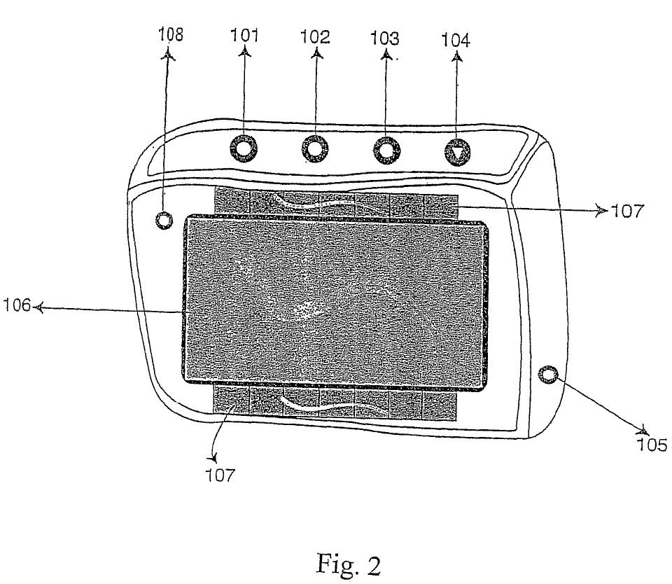

The inventive parking checker arrangement relates to an automatic pager device designed to pay and display the paid amount charged for parking cars in car parking areas, preferably with a display unit to display the paid amount (FIG. 2).

FIG. 2 illustrates a pager device with key pad, which including menu, choose and send functions 101,102 & 103, a spare-function key 104, display monitor 106, battery recharging unit working by solar recharging system 107, charger cable terminal 105 to charge the battery, and an integrated internal storage chip (not shown).

The pager device is optionally also equipped with a proximity-sensor that switches on a screen illumination for the display monitor 106 in response to passing a hand over the pager, for instance by a parking inspector passing his hand in front the car windscreen over the pager, to check the displayed paid parking time at night or in poor lighting conditions.

FIG. 3 illustrates a diagram of a remote payment server, using a mobile phone 301, connectable to GSM or any other wide-area network 305 connectable to an authorization/authentication server 302, connectable to a cord/cordless network 306, connectable to a payment server 303, which connects to a GSM or other network 305, connectable to the pager device 304 in the car parking area which charges calculated according to the parking time, and then sends a return signal on the same route, as shown in the diagram of FIG. 3, in the reverse direction until the signal reaches the mobile phone 301 of the caller to confirm the payment and authorize the required parking time or highway toll.

FIG. 4 illustrates a diagram of a remote payment system which uses a dual-route device that is connectable with GSM or GPRS or other wide-area network 404, connectable with an authorization server 402 connectable to a cord/cordless network 405, connectable with a payment server 403 which calculates the charges according to the required time and sends a return signal on the same route as shown in FIG. 4 in the reverse direction, until the signal reaches the pager device 401 to confirm the payment has been made and authorizes the required parking time.

### Loading of the Storage Chip

The pager device has a contactless storage chip with a value loading capacity. The loading and reloading of a value in the contactless storage chip is achieved through an authorized loading station whereas the car drivers or owners enter the desired amount whether cash or by credit card or other to add the required amount to the chip of the pager device of the invention, for example by placing the device in the proximity of the loading station which is linked to a payment device.

Another way of the loading a monetary value on the chip is similar to the loading of pre-paid cards on mobile phones, by scratching the covered ply of a secret number on a pre-paid card and loading the value to the mobile phone, using the secret number as a security code. The loading of a value on a pre-paid card to the inventive automatic equipment for paying car parking charges from a mobile phone can be done by entering the device number of the pager device according to the invention, entering the pre-paid card number then pressing on the sending key. The value will be loaded or reloaded according to the nominated system by the loading device.

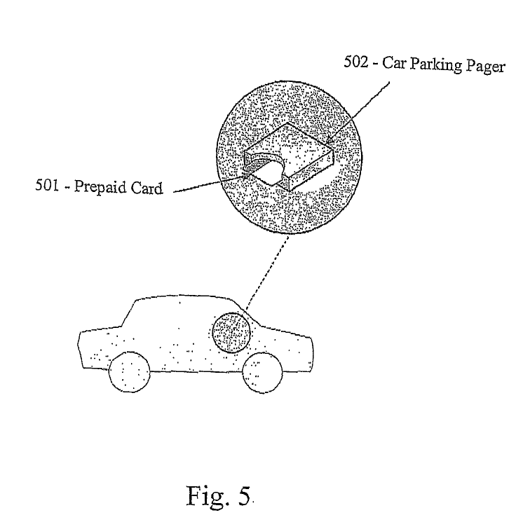

FIG. 5 illustrates a car parking pager that accepts a pre-paid card. As shown, the pager parking device 502 has a slot for receiving a pre-paid chip card 501, typically of credit-card format and type with a magnetic strip and/or a storage chip. Insertion of this card 501 in the pager 502's slot serves to recharge the parking device which works on the residual value stored in the card 501, or transferred to the device 502, by deduction of the accumulating parking charges from the residual amount.

The pager's contactless storage chip can also be loaded with a monetary value by transfer of a value stored in a mobile phone, e.g. by loading a value from a pre-paid card onto a mobile phone as just described above, and transferring the value to the pager.

### Paying the Car Parking Charges by Hand/Automatic Way

When the motorist knows the exact period that he wishes to leave his car on the car park, he will pay the required car parking charges from the stored value on the pager device of the car parking, by pressing the key 101 which displays on the device screen 106 the expected waiting period for the car or vehicle. The parking charge is then made via a payment server, as explained below, which provides a confirmation-of-payment message whereupon the paid parking time is displayed. Then the device or display unit will be placed in the front side of the car behind the front windscreen or in any other place nominated by the parking authority to enable the inspectors or in-charge employees to check the device and confirm payment of the car parking charges.

When the car driver or owner expects to park for a given period but knows that he may exceed the paid time, he could press on key 102 for example which initiates a function for automatic renewal of the parking period. By this action, the pager device will automatically calculate the initial parking time on the parking area. When the previous paid-for period has expired the device will not stop but continue to calculate by adding an extra hour to the calculated period. Each extra charge can be debited automatically from the amount stored on the storage chip, as the charge arises. When the driver or owner returns to the vehicle he stops the calculation of the extra time and parking charges of his car, and at this point the charging will stop.

### Payment by Server

WO 2004/012352 discloses a wireless mobile device used to conduct financial transactions using a contactless smartcard, in particular by combining a contactless card reader with a mobile phone. The financial transactions include face-to-face or remote purchases, payment with electronic cash stored in the contactless card, or payment with a contactless card through a financial institution, and downloading and storing of digital goods or services in the contactless card.

It is noted that WO 2004/012352 discloses a payment mechanism that can be used to implement the parking charging system of this invention. The disclosure of WO 2004/012352 is therefore incorporated herein by way of reference as background for how a car parking pager according to the invention transacts with a payment server and authentication server as similar to mobile user equipped with a contactless card.

### Payment by Two-Way Pager Via Satellite or Payment Server

Recent pagers are equipped with a numeric or alphanumeric display. This pager is capable of displaying a message sent by transmitters using a digital code, which contains the text of the message being sent. These paging systems may use a protocol such as the post office code Standardization advisory group (POCSAG) or Golay sequential code (GSC).

Previous paging systems were strictly one-way. There was no confirmation to the sender that a message has not actually reached the pager, nor did the user have any means of sending an answer via his pager.

To remedy this limitation, pagers have been developed which allow two-way communication, which have individual transmission capability. When a base station calls a pager of this type, the pager transmits its ID code to the base station, which is an affirmative response that the pager has received the call.

The invention advantageously implements a 2-way pager with SMS sending/receiving capacity. U.S. Pat. No. 6,731,942 discloses such a system that utilizes a communication protocol which allows a dispatcher station and a pager of the paging system to communicate over the GSM/GPRS network in a predetermined manner. This patent discloses how a pager can transmit a message to payment server or authority to get in return confirmation, which can be used in the implementation of the present invention for the confirmation of parking payments and times that can be displayed on the pager's screen.

### Checking of Paid Parking Time by the Portable Hand-Held Checker Device

Checking of paid parking time by the portable hand-held checker device 11 is very simple. The parking inspector 13 carrying the checker device 11 approaches a parked car 14 until he is within the operating range of the ISM-band or other data link of the local wireless application. He then points the switched-on checker device 11 towards the car 13. The checker device 11 for example operates with RFID technology, and the emitted radio wave is received by the antenna 16 of the pager device 12's chip 15. If the pager device's chip 15 has recorded a pre-paid parking time (by cooperating with the wide-area radio network 305) it calculates the residual parking payment as a function of elapsed parking time and records whether or not the pager still has a residual parking fee or a corresponding residual paid time. If there is a residual fee/time, the pager issues a signal indicating this by a colour or a sign that appears on the screen 14 of the checker device 11. If there is no residual parking time, or if paid parking time has expired or if there is no signal (for instance if there is no pager in the vehicle or if the pager is switched OFF), the pager device 12 emits a signal (or no signal) which indicates this status on the screen 14 by another colour or sign. Alternatively, the pager's signal may indicate the amount of residual parking payment or corresponding time, or the status such as the time elapsed since expiry of a paid parking fee, etc. and such can be indicated on the checker device 11 in a suitable way.

The above-mentioned signals can also be used to generate fine tickets for unpaid car parking charges or wrongly-parked cars directly through the hand-held device 11. For this purpose, the hand-held checker device 11 can be provided with a known type of printer associated with means for feeding a roll of paper, and a keyboard 16 for the inspector to enter commands. Also, for the purpose of issuing fines the parking inspector can obtain, through the GSM or another wide-range telephone network, any required electronically-transferred data by connecting to a police or municipal computer. For instance, the car number plate can be used to obtain information if the vehicle is stolen, etc.

Checking of the status of paid parking fees for individual vehicles is thus simple and rapid with the easy-to-use hand-held portable checker device 11 of simple construction, and that does not rely on a connection to the wide-range wireless network.

### DETAILED DESCRIPTION OF THE OPERATION

FIG. 3 illustrates a diagram of the payment server, using a mobile phone 301 that the user connects via GSM or other network 305 to the authorization server 302. The latter is connected via network 306 to the payment server 303, which connects via GSM or other network 305 to the pager device 304 in a car parking area. A message from the pager device 304 can be sent in reverse direction back to the mobile phone 301 to confirming that the sent message has been executed.

The device of FIG. 3 works as in the following steps:

The motorist using his/her mobile phone 301 enters the number of the car parking pager 304 and the required time for car parking, as well as a code identifying the car parking area if the device is being operated manually, or an automatic identification of the parking area by GPS. This information is transferred to the authorization server 302 via network 305, which calculates the amount to be charged and sends this information to payment server 303 through network 306. The payment server 303 also sends the information to the car parking pager device 304 through network 305. An SMS or NMS confirmation of payment message is sent to the pager 304 to display the authorized period on the pager's screen 106. This payment server 303 receives and transmits the message or order from motorist and subscriber in a short message service (SMS) or numeric message service (NMS) to the motorist's pager 304 via relatively low bit rate radio frequency communication channel or other. To provide the needed confirmation that the motorist's instruction reached the car-parking pager device 304 if the driver is far from the vehicle, the information is sent from the pager 304 via the reverse route as shown in FIG. 3 to deliver this information to the driver via phone (e.g. by an SMS) to confirm the execution of his instruction, and that the required car parking period is displayed on the screen 106.

The motorist's pager 304 is a two-way pager that receives and transmits information from and to the communication system that authorizes and executes payment. Further details of how such a two-way pager system can operate are given in U.S. Pat. No. 6,731,942.

FIG. 4 illustrates a diagram of the payment system using a dual-route device for connecting the pager 401, via GSM or GPRS or other network, with the authorization server 402 connected by network 405 with payment server 403 which calculates the charges according to the required time and sends a return signal on the same route as shown in FIG. 4 in reverse direction, until the signal reaches to the pager device 401 to confirms the payment and authorize the required time.

To implement the arrangement of FIG. 4 the pager 401 will be equipped with an alpha-numeric key pad which allows the motorist or vehicle owner or others by pressing the pre-determined keys of the pager display to send a message e.g. by SMS requesting for paid parking permit to the payment server and for confirmation via satellite or GSM/GPRS or another network.

### Procedure for Charging the Pager Device

Prior to charging, the Parking Device has to be brought in the vicinity of the wireless transceiver (approximately one or several meters or as per requirements) of the charging station 17 which is equipped with a notebook or PC 18 with charging-station software.

To initiate the charging process the connect button has to be pressed. The parking device then finds and looks for the charging station and will authenticate and establish a wireless communication path.

When the authentication is successfully established, the screen of the charging PC machine turns to a specific colour (e.g. yellow) or provides another signal which indicates that the parking device is ready for charging. Then, a desired charging amount has to be entered within a specified period, e.g. 10 seconds, and the user must press on the enter button “E” to confirm charging. After the specified period (say 10 seconds) the parking device cancels communication for re-charging the device by means of the charging PC device, inter alia for security reasons.

After successfully establishing communication, the charged amount will be displayed on the parking device's screen for a short while, and then the parking device returns to the “main menu” screen.

The above-described charging can also be done using the portable hand-held charger 11.

The pager device can also be charged from a pre-paid card, as described above in connection with FIG. 5.

### Extra Features and Advantages

The pager for car parking will preferably be equipped with two batteries. One battery will be for powering the memory of time and date and other required information that is programmed by the pager issuing authority, and for powering an active RFID where the pager incorporates one. This battery could be connected to the solar-powered device 107 for charging the battery and for powering the pager display unit. Further details of solar-operated recharging are given in EP-A-1,246,340.

EP-A-1,246,340 discloses that a solar-powered device could be disposed on a battery unit of a mobile handset to charge the battery unit. This invention keeping this as a background for charging the battery of pager from solar or other source of light to give long life of the battery.

The second battery of the pager could be a rechargeable battery or a normal lithium battery for example, or another battery for powering illumination of the pager display screen 106 for a parking inspector to check the parking charges. The second battery can also power the function of pager from the keypad to choose and display the requested parking time.

One of the pager keys, e.g. the spare-function key 104, can display the state of battery charging.

To promote the sale of goods in shopping malls, according to the invention, the pager could incorporate a function enabling a shopkeeper to take over the parking charges of customers. Thus the shopkeeper by phoning the number of the pager could have the current parking charge transferred to his account. The same applies to visitors of paid parking areas whose parking charges could be paid by a host.

The described device could be used to achieve more advantages by providing more programs with more function keys, for example asking a parking authority for help if anything happened to the vehicle by sending messages to the car parking device authority.

The pager could also send a paging message to the motorist's mobile phone alerting him of expiry of the set parking time, or when a maximum legal parking time has been reached, or when the amount of credit stored in the storage chip is low or depleted, or if the pager batteries are low.

The pager can also have a “ready” setting when it is placed in the vehicle at a visible location, so it will only accept remote payment orders when this “ready” setting is on.

In addition to the payment of parking charges and the display of paid parking time, the pager can also perform other functions like alerting unauthorized entry into or the theft of the vehicle, as well as the payment of toll charges on highways, bridges or tunnels, etc.

As mentioned, the pager can incorporate or be associated with a GPS device. In this case the GPS device can identify position of the vehicle and hence the parking place where the vehicle is being parked, and automatically provide the necessary identification signal of the parking location.

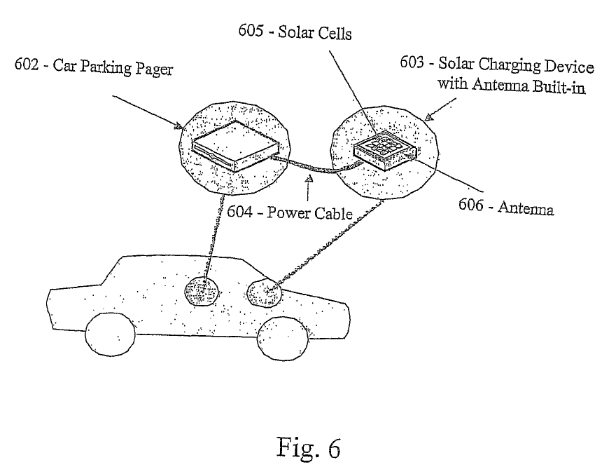

FIG. 6 illustrates a car parking pager 602 that has a solar charging device 603 with a built-in antenna 606. The solar charging device 603 comprises an array of solar cells 605 on its front face and a special antenna 606 whose periphery surrounds the solar cells 605. This device 605 is connected to the car parking pager 602 by a cable 604 for power transmission. The antenna 606 operates at RFID frequency, or another radio frequency. This solar charging device 603 with the built-in antenna can be placed on an automobile's front dashboard, under the windscreen, or in another location suitable for solar charging and for the antenna to pick up and emit radio signals. The car parking pager 602, on the other hand, can be stored for example in a dashboard compartment where it is out of sight. The power produced by the solar cells 605 powers the pager 602, in particular it powers the pager's storage chip. The solar cells 605 can also serve for charging one or more batteries that power the pager and its active RFID.

It is also possible to divide the pager's memory into a plurality of parts or zones each of which can store data defining different parking conditions in different places such as in several cities. In this way, the pager can be can adjusted to given parking conditions, in particular to different cities parking charges, by the user selecting the parts or zones of the memory, or by automatically selecting the parts or zones of the memory by GPS.

The payment calculation, based on the identification of the parking place, its parking charges and the intended parking time can be performed by the authentication server (302,402) and/or by the payment server (303,403) and/or can be made at least in part in the parking pager manually (by providing the pager with a function to select parking charges), semi-automatically or automatically (especially when the pager is used with a GPS). The payment calculation will take into account discrepancies between the requested parking time and the chargeable period. For example, if the user requests 3 hours parking up to 10 pm, but the parking charges are made only up to 9 pm, the software will not accept extra payment for the period from 9 pm to 10 pm, or could extend the paid parking period to the next charged period for the next day.

1. A system for checking the payment of vehicle parking charges comprising:
a vehicle-portable parking meter device (12) for paying vehicle parking charges that is installed or installable in or on a vehicle (14), the vehicle-portable parking meter device (12) comprising a contact or contactless storage chip (15) that is loadable with an amount of credit usable as parking fees, the storage chip being associated with an antenna (16) for wireless connection of the storage chip with a wireless-operable credit-loading device (17,303,403); and
a portable hand-held checker device (11) usable by a parking inspector (13) to check the payment status of a parking meter device (12) that is installed in or on a parked vehicle (14), the checker device (11) when in the vicinity of the parked vehicle being connectable with the parking meter device's storage chip (15) via its antenna (16) using a local short-distance wireless or RFID or IR transmission whereby the parking inspector can check whether or not the parking meter device (12) has residual paid parking time.

2. The system of claim 1, further comprising a wireless-operated credit-loading device that comprises a local charging station (17) having a wireless transceiver, the local charging station (17) being equipped with a notebook or PC (18) with charging-station software, the local charging station (17) being operably connectable to the parking meter device (12) by short-distance wireless or RFID or IR transmission when the local charging station (17) and the parking meter device (12) are in the vicinity of one another.

3. The system of claim 1, wherein the storage chip (15) of the parking meter device (12) is connectable via GSM or other wide-area radio network (305,306,404,405) to a remote payment server (303,403) for loading credit and paying parking fees by deducting from the amount of credit in the storage chip (15).

4. The system of claim 1, 2 or 3, wherein storage chips of the parking meter device (12) and the checker device (11) are each associated with a RFID (radio frequency identification device) incorporating an antenna, and the local wireless application operates with RFID technology.

5. The system of any preceding claim, wherein the checker device (11) is arranged to send a signal that triggers renewal of a paid parking period on the parking meter device (12) via the credit loading device (17,303,403).

6. The system of claim 5, wherein the checker device (11) is arranged to send said signal that triggers renewal of a paid parking period on the pager via the local short-distance wireless or RFID or infra-red transmission.

7. The system of any preceding claim, wherein the parking meter device is arranged for entering an intended parking time and an identification of the parking place by manual actuation of the parking meter device (12) or by a local charging station (17) by short-distance wireless or RFID or IPR transmission, or by remote control via a wide-area radio network (301,305,306), and for transmitting a message corresponding to the intended parking time and parking place to the parking meter device (12).

8. The system of any preceding claim, wherein the parking meter device (12) comprises a pager (304,401) that has a display screen (106) for displaying paid parking time, the pager (304,401) being installed or installable in or on a vehicle (14).

9. The system of claim 8, wherein the pager display screen (106) is arranged to display paid parking time in correspondence with the intended parking time and with an amount of credit deducted as paid parking fee, paid parking time being displayed by the display screen (106) in response to a confirmation-of-payment message sent from a charging station or payment server (17,303,403) to the pager (304,401).

10. The system of claim 9, wherein the pager (304,401) comprises a plurality of function keys (101-104) enabling the user to actuate different functions on the device including selection of payment methods and display of selected information such as a payment amount.

11. The system of claim 10, wherein the pager comprises a function key for actuating automatic renewal of a parking period and displaying an extended paid parking time when a paid parking period expires.

12. The system of any preceding claim, wherein the storage chip (15) of the parking meter device (12) is associated with an active RFID (radio frequency identification device) and the pager and its active RFID are powered by at least one battery.

13. The system of claim 12, comprising a solar-operated battery charging device (107) for charging at least one of the batteries.

14. The system of any preceding claim, which further comprises a payment server (303,403) for paying parking fees by deduction from the amount of credit in the pager's storage chip which is connectable via a GSM or other radio network (305,306; 404,405) to the payment server (303,403); the system being arranged for entering an intended parking time and an identification of a parking place by manual actuation of the parking meter device (12) or by remote control via a wide-area radio network (301,305,306) or via said local short-distance wireless or RFID or IR transmission, and for transmitting a message corresponding to the intended parking time and parking place to the payment server (303,403).

15. The system of claim 14, wherein the parking meter device (12) comprises a pager (304,401) having a display screen (106) arranged to display paid parking time in correspondence with the intended parking time and with an amount of credit deducted as paid parking fee, paid parking time being displayed by the display screen (106) in response to a confirmation-of-payment message sent from the a charging station or payment server (17,303,403) to the pager (304,401).

16. A portable hand-held parking checker device of a system according to any preceding claim, wherein the checker device (11) is operatively connectable to the parking meter device (12) by a local short-distance wireless or RFID or infra-red transmission, the checker device comprising a screen (15) for displaying information about vehicle parking charges transmitted by the parking meter device (12) via the local short-distance wireless or RFID or infra-red transmission.

17. The parking checker device of claim 16, wherein the checker device (11) comprises a RFID reader.

18. The parking checker device of claim 16 or 17, wherein the checker device (11) is also operatively connectable to a wide-area wireless network (305,306; 404,405).

19. The parking checker device of claim 16, 17 or 18, wherein the checker device (11) comprises means for generating parking tickets including an indication of a surcharge or fine as a function of information, transmitted by the parking meter device (12) via the local short-distance wireless or RFID or infra-red transmission, concerning unpaid or expired parking time.
